(19) United States
(12) Patent Application Publication
(10) Pub. No.: US 2006/0185009 A1
(43) Pub. Date: Aug. 17, 2006

(54) Communication apparatus and communication method

(75) Inventors: Hiroshige Kamine, Fukuoka-shi (JP); Keizo Sato, Kasuga-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/354,143

(22) Filed: Feb. 15, 2006

(30) Foreign Application Priority Data
Feb. 16, 2005 (JP) 2005-038826

(51) Int. Cl. G06F 15/16; G06F 17/00; G06F 9/00

(52) U.S. Cl. 726/11; 726/13; 726/14

(57) ABSTRACT

To make it possible, even for each of general users who is not familiar with the setting of an IP network, to automatically connect to and communicate with an apparatus within a firewall from the outside of the firewall without changing the setting of the firewall, a personal computer PC 2 generates a temporal IP address, then the PC 2 sends a notification to an unspecified number of partner-side apparatuses by the broadcasting transmission so as to set the temporal IP address thus generated, then a communication terminal 3a sets the IP address thus notified as a temporal address in place of the original IP address of the own communication terminal. Then, the PC 2 transmits an IP address request for the partner-side apparatus to the temporal IP address, then the communication terminal 3a transmits the original IP address of the own communication terminal in response to the IP address request addressed to the temporal IP address, then the communication terminal 3a changes the IP address of the own communication terminal to the original IP address from the temporal IP address, and the PC 2 obtains the IP address sent in response to the IP address request.

### BACKGROUND OF THE INVENTION

1. Field of the Invention

The present invention relates to a communication apparatus and a communication method for communicating via a firewall.

2. Description of the Related Art

In recent years, communicating infrastructure such as ADSL (Asymmetric Digital Subscriber Line) or FTTH (Fiber To The Home) has been prepared and so the utilization of web sites and e-mails have rapidly increased in number. On the other hand, the abuses of e-mails such as computer virus or attacks from ill-intentioned users have appeared much. In order to protect a computer from such attacks, there is the system of a firewall which allows only communications satisfying a certain condition.

This kind of firewall determines whether or not communication data is to be passed therethrough depending on the IP (Internet Protocol) address, the port number etc. of a transmission source or a transmission destination thereby to prevent an illegal access. When a firewall is used, although it is possible to communicate to an apparatus outside of the firewall from a computer within the firewall, a communication in the reverse direction, that is, a communication to the computer within the firewall from an apparatus outside of the firewall is limited.

However, there arises another problem in an environment where the firewall is introduced. That is, when it is intended to connect to a computer within the firewall from an apparatus outside of the firewall, even if a communication is legal, the communication originated from the apparatus outside of the firewall is interrupted by the firewall and so can not pass the firewall. Techniques for solving such a problem are disclosed in patent documents 1 to 3, for example.

As a kind of firewalls, there is a packet filtering type firewall which limits communications at the network layer and the transport layer of the OSI (Open Systems Interconnection) basic reference model. The packet filtering type firewall generally has a basic policy which is arranged to allow a communication from a partner-side apparatus outside of the firewall responding to a communication originated from a computer within the firewall but reject a communication originated from the partner-side apparatus.

The related art is recited in JP-A-2002-328887, JP-A-2003-323360, and JP-A-2004-5418.

Although it is necessary to know in advance the IP address of a partner-side apparatus in order to communicate between apparatuses via such the packet filtering type firewall, it is not easy to obtain the IP address of the partner-side apparatus. This is because, for each of general users who is not familiar with the setting of the IP network, it is difficult to know the IP address of the user's apparatus and further the user must change the setting of the firewall concerning communication with respect to the IP address.

Further, in the case of adding a new apparatus outside of the firewall, even if it is intended to automatically notify the IP address of the new apparatus to the apparatus within the firewall from the apparatus outside of the firewall, a communication originated from the apparatus outside of the firewall is interrupted by the firewall. In contrast, the apparatus within the firewall also does not know the IP address of the newly added apparatus and so can not request the IP address of the new apparatus from the new apparatus.

### SUMMARY OF THE INVENTION

Accordingly, an object of the invention is to provide a communication method, a communication system, a communication apparatus and a communication program each of which makes it possible, even for each of general users who is not familiar with the setting of the IP network, to automatically connect to and communicate with an apparatus within a firewall from the outside of the firewall without changing the setting of the firewall.

In order to solve the aforesaid problem, the invention is arranged in a manner that a first communication apparatus generates a temporal IP address, then the first communication apparatus sends a notification to an unspecified number of partner-side apparatuses by the broadcasting transmission so as to set the temporal IP address thus generated, then a second communication apparatus sets the IP address thus notified as a temporal address in place of the original IP address of the own communication terminal, then, the first communication apparatus transmits an IP address request for the partner-side apparatus to the temporal IP address, then the second communication apparatus transmits the original IP address of the own communication terminal in response to the IP address request addressed to the temporal IP address, then the second communication apparatus changes the IP address of the own communication terminal to the original IP address from the temporal IP address, and the first communication apparatus obtains the IP address sent in response to the IP address request.

According to the invention, the first communication apparatus can obtain the original IP address of the second communication apparatus and communicate with the second communication apparatus by using the IP address. Thus, it is possible, even for each of general users who is not familiar with the setting of the IP network, to automatically connect to and communicate with the first communication apparatus within the firewall from the second communication apparatus outside of the firewall without changing the setting of the firewall.

### BRIEF DESCRIPTION OF THE DRAWINGS

FIG. 1 is a diagram for explaining the basic policy of a firewall in an embodiment of the invention.

FIG. 2 is a diagram showing an example of the configuration of the communication system according to the embodiment of the invention.

FIG. 3 is a functional block diagram showing the communication system according to the embodiment of the invention.

FIG. 4 is a flowchart of the IP address solving procedure in the communication system according to the embodiment of the invention.

FIG. 5 (a), (b) are explanatory diagrams showing an example where a communication is performed at a layer which level is lower than the network layer.

### DESCRIPTION OF THE PREFERRED EMBODIMENTS

An embodiment of the invention will be explained with reference to the accompanying drawings.

### Embodiment

The firewall used in the embodiment of the invention is the packet filtering type firewall which limits communications at the network layer and the transport layer of the OSI basic reference model. The packet filtering type firewall determines whether communication data is to be passed or not in accordance with the IF address and the port number of a transmission source or a transmission destination thereby to prevent illegal access.

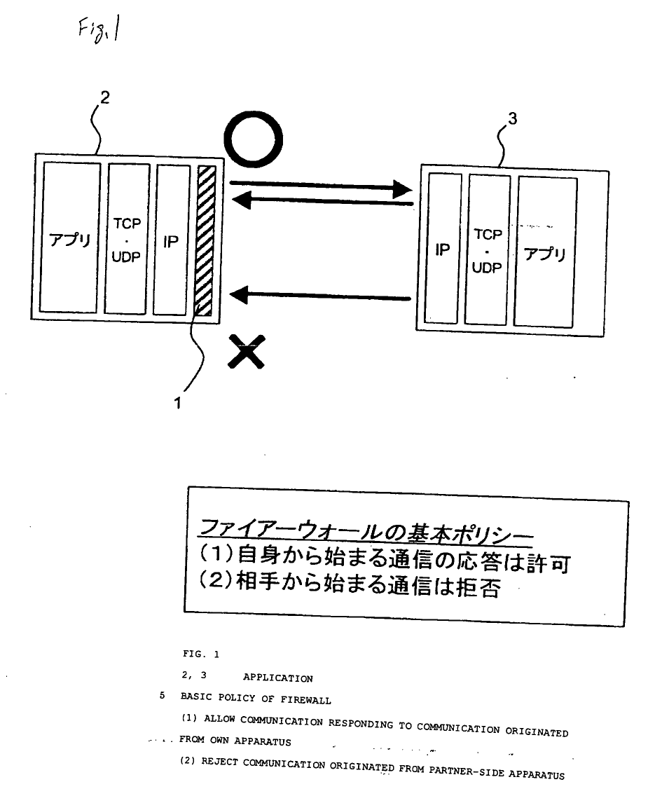

FIG. 1 is a diagram for explaining the basic policy of the firewall in the embodiment of the invention. The firewall 1 shown in FIG. 1 has the basic policy which protects a personal computer (hereinafter called as a PC) 2 serving as a communication apparatus in a manner of allowing a communication from a communication terminal 3 (disposed outside of the firewall 1) serving as a partner-side communication apparatus responding to a communication originated from the PC 2 but rejecting a communication originated from the partner-side communication terminal 3. The following explanation will be made as to the processing in a state that the PC 2 is effectively protected by the firewall 1 having the basic policy.

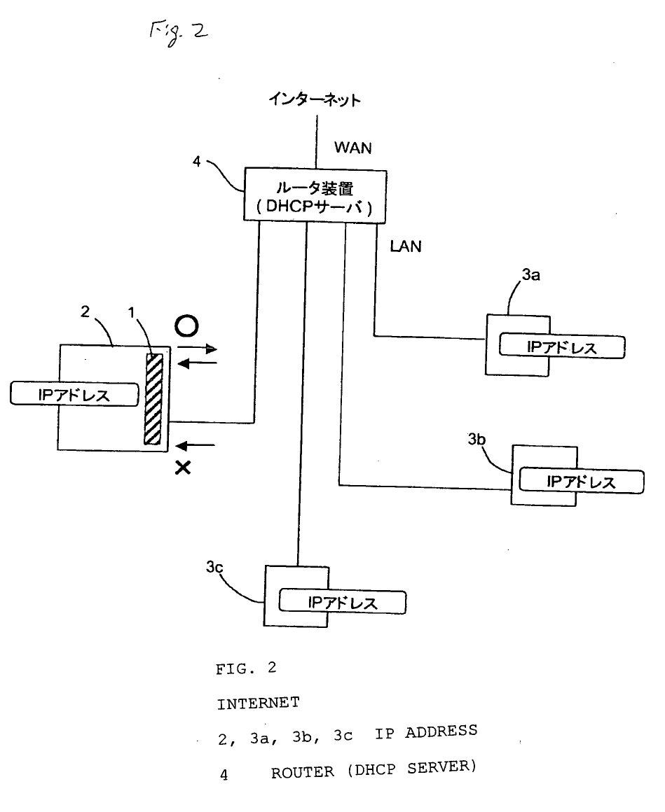

FIG. 2 is a diagram showing an example of the configuration of the communication system according to the embodiment of the invention. In FIG. 2, the communication system according to the embodiment of the invention is configured by the PC 2, the communication terminals 3a, 3b, 3c and a router 4 which are mutually coupled via a LAN (Local Area Network). The router 4 has a DHCP (Dynamic Host Configuration Protocol) server function for automatically allocating IP addresses to the PC 2 and the communication terminals 3a, 3b, 3c coupled to the LAN side, respectively. The WNA (Wide Area Netwrok) side of the router 4 is normally coupled to the internet.

The following explanation will be made as to a case where the communication terminal 3a communicates with the PC 2 as the communication terminal 3 shown in FIG. 1. Each of the PC 2 and the communication terminal 3 executes a predetermined communication program to operate as an apparatus explained below.

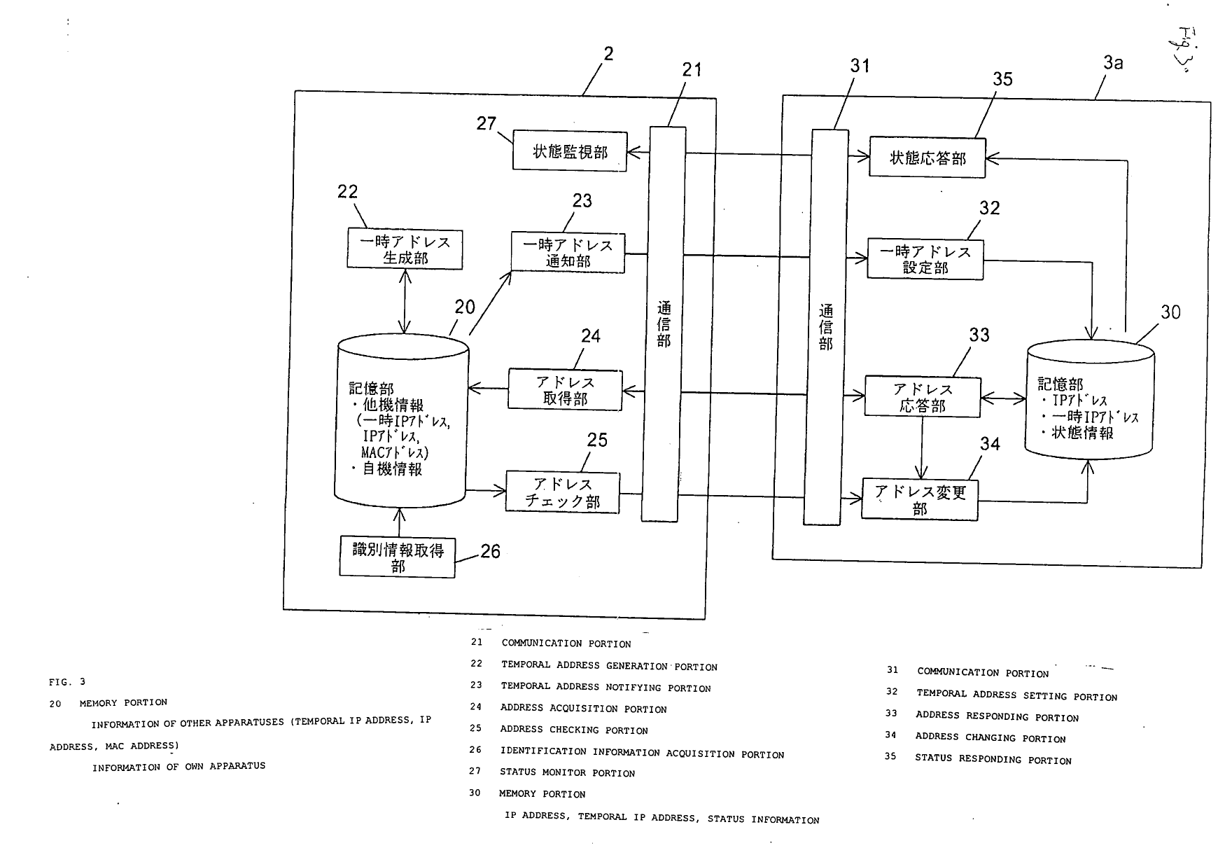

FIG. 3 is a functional block diagram showing the communication system according to the embodiment of the invention.

As shown in FIG. 3, the PC 2 includes a memory portion 20 for storing various kinds of information, a communication portion 21 for communicating with the communication terminal 3 etc. such as the communication terminals 3a, 3b, 3c coupled to the communication network, a temporal address generation portion 22 for generating a temporally set IP address (hereinafter called as a temporal IP address), a temporal address notifying portion 23 for notifying the temporal IP address generated by the temporal address generation portion 22, an address acquisition portion 24 for obtaining an IP address from the another communication terminal 3 by using the temporal IP address generated by the temporal address generation portion 22, an address changing portion 25 for checking the IP address obtained by the address acquisition portion 24, and an identification information acquisition portion 26 for obtaining an identification information for identifying the communication terminal 3a to be connected.

The memory portion 20 stores, as information of other apparatuses, the temporal IP address generated by the temporal address generation portion 22 and an IP address obtained by using the temporal IP address. The memory portion 20 further stores the IP address etc. of the PC 2 as information of own apparatus for communicating by the communication portion 21. The respective portions of the PC 2 send and receive information to and from the other communication terminals 3 via the communication portion 21.

The temporal address generation portion 22 generates the temporal IP address for temporarily setting for the communication terminal 3a to be connected based on a predetermined operation expression or randomly. The IP address generated by the temporal address generation portion 22 is an IP address including a network address like the IP address of the PC 2. The temporal address generation portion 22 may be configured to generate the temporal IP address based on an identification information (such as a MAC address) peculiar to the communication terminal 3a.

The temporal address notifying portion 23 sends a notification (a temporal IP address setting notification) to an unspecified number of partner-side apparatuses by the broadcasting transmission to the communication network so as to set the temporal IP address which is generated by the temporal address generation portion 22 and stored in the memory portion 20. The broadcasting transmission can be performed by using the UDP (User Datagram Protocol). Incidentally, the temporal address notifying portion 23 maybe configured to broadcast the data portion of the UDP added with the identification information peculiar to the communication terminal 3a so that the communication terminal 3a to be connected can identify that the temporal IP address setting notification broadcasted to the unspecified number of partner-side apparatuses is addressed to the communication terminal 3a.

The address acquisition portion 24 transmits an IP address request for the partner-side apparatus to the temporal IP address notified by the temporal address notifying portion 23 and obtains. an IP address sent in response to the IP address request. The IP address request can be sent by using the UDP, TCP (Transmission Control Protocol) or ICMP (Internet Control Message Protocol). The address acquisition portion 24 stores the IP address thus obtained in the memory portion 20.

When the IP address of a partner-side apparatus obtained by the address acquisition portion 24 includes a network address which is different from a network address contained in the IP address of the own apparatus, the own apparatus can not communicate with the partner-side apparatus by using the obtained IP address. Thus, in this case, the address changing portion 25 notifies the partner-side apparatus so as to set the IP address including the network address same as that contained in the IP address of the own apparatus. Further, when the obtained IP address overlaps with that of the other communication terminal 3 etc. within the communication network, the address changing portion 25 notifies the partner-side apparatus so as to set an IP address not overlapping with that of the other communication terminal 3 etc.

The identification information acquisition portion 26 obtains the identification information peculiar to the communication terminal 3a through the input etc. from an input device such as a key board etc. The identification information acquisition portion 26 stores the obtained identification information into the potion 20.

The communication terminal 3a includes a memory portion 30 for storing various kinds of information such as the temporal address notified from the PC 2 and status information, a communication portion 31 for communicating with the PC 2 and the communication terminal 3 etc. such as the communication terminals 3b, 3c coupled to the communication network, a temporal address setting portion 32 for setting a temporal IP address by the IP address notified from the PC 2, an address responding portion 33 for notifying the IP address of own communication terminal in response to the IP address request from the PC 2, and an address changing portion 34 for changing the IP address of the own communication terminal. The respective portions of the communication terminal 3a send and receive information to and from the PC 2 via the communication portion 31.

The temporal address setting portion 32 sets the temporal IP address notified from the PC2 as a temporarily set IP address in place of the original IP address of the own communication terminal. In this case, as described above, when the data portion of the UDP is added with the identification information peculiar to the communication terminal 3a at the PC 2, the temporal address setting portion 32 can determine that the broadcast transmission is addressed to the own communication terminal from the identification information of the data portion of the UDP.

The address responding portion 33 transmits the IP address of the own communication terminal stored in the memory portion 30 in response to the IP address request addressed to the temporal IP address set by the temporal address setting portion 32. The response to the IP address request can be performed by using the UDP, TCP or ICMP like the IP address request sent from the PC 2.

The address changing portion 34 serves to change the IP address of the own communication terminal from the original IP address to the temporal IP address, to change the IP address of the own communication terminal from the temporal IP address to the original IP and to change the IP address based on the notification from the address changing portion 25 of the PC 2.

Next, the explanation will be made as to the processing of the communication system configured in this manner.

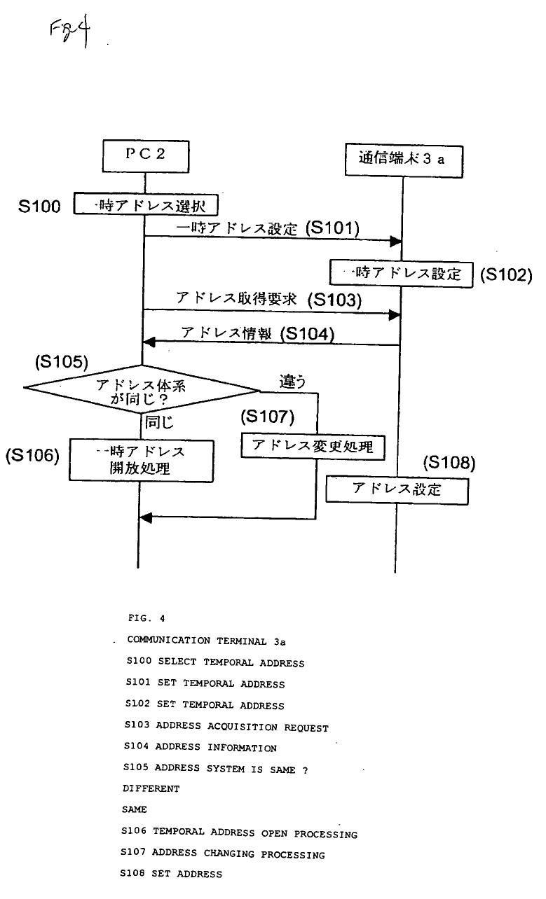

FIG. 4 is a flowchart of the IP address solving procedure in the communication system according to the embodiment of the invention.

Step S100

The PC 2 periodically monitors by performing the polling to generate an IP address not used within the communication network by the temporal address generation portion 22 thereby to select the IP address thus generated as the temporal IP address.

Step S101

The temporal address notifying portion 23 sends the notification to an unspecified number of partner-side apparatuses (the communication terminals 3a, 3b, 3c in the example of FIG. 2) within the LAN by the broadcasting transmission so as to set the temporal IP address which is generated in step S100. In this case, as described above, the temporal address notifying portion may be configured to broadcast the data portion of the UDP added with the identification information such as the MAC address peculiar to the communication terminal 3a. The identification information peculiar to the communication terminal 3a is preferably obtained by the identification information acquisition portion 26 in advance.

Step S102

The communication terminal 3a to be connected to the PC 2 sets, by using the temporal address setting portion 32, the temporal IP address notified by the broadcasting transmission as the temporarily set IP address in place of the original IP address of the own communication terminal. When the data portion of the UDP of the broadcasting transmission is added with the identification information such as the MAC address peculiar to the communication terminal 3a, this communication terminal can identify that the broadcast transmission is addressed to the own communication terminal from the identification information of the data portion of the UDP.

Step S103

The address acquisition portion 24 of the PC 2 transmits the IP address request for the partner-side apparatus (the communication terminal 3a in this example) to the temporal IP address notified by step S101.

Step S104

The address responding portion 33 of the communication terminal 3a transmits the original IP address of the own communication terminal in response to the IP address request addressed to the temporal IP address. Since this response is a communication responding to the communication originated from the PC 2, this response passes the firewall 1 and reaches the PC 2.

Step S105

The address acquisition portion 24 of the PC 2 obtains the IP address responded from the communication terminal 3a in step S104. Then, the address changing portion 25 checks the IP address thus obtained whether or not the address system of the obtained IP address is same as that of the IP address of the own apparatus, that is, whether or not the network address of the obtained IP address is same as that of the IP address of the own apparatus.

Step S106

When it is determined in step 105 that the address system of the obtained IP address is same as that of the IP address of the own apparatus, the PC 2 opens the temporal IP address stored in the memory portion 20.

Step S107

When it is determined in step 105 that the address system of the obtained IP address is different from that of the IP address of the own apparatus, the address changing portion 25 of the PC 2 notifies the communication terminal so as to set the IP address including the network address same as that contained in the IP address of the own apparatus.

Step S108

When the communication terminal 3a is notified by the address changing portion 25 to change the IP address thereof, the address changing portion 34 changes the IP address of the own communication terminal based on the notification. In contrast, when the communication terminal 3a is not notified by the address changing portion 25 to change the IP address thereof, the address changing portion 34 changes the IP address of the own communication terminal to the original IP address from the temporal IP address.

As described above, in the communication system according to the embodiment of the invention, the communication terminal 3a outside of the firewall 1 communicates with the PC 2 by using the temporal IP address generated by the PC 2 at the inside of the firewall 1 and can notify the original IP address of the own communication terminal to the PC 2. Thus, the PC 2 can obtain the original IP address of the communication terminal 3a and so can communicate with the communication terminal 3a via the firewall 1 by using the obtained IP address.

That is, in the communication system according to the embodiment of the invention, it is possible, even for each of general users who is not familiar with the setting of the IP network, to automatically connect to and communicate with the PC 2 within the firewall 1 from the communication terminal 3a outside of the firewall 1 without changing the setting of the firewall 1.

In the communication system according to the embodiment of the invention, since the broadcasting communication at the time of notifying the temporal IP address by the temporal address notifying portion 23 is performed by using the UDP, it is not necessary to know the IP address of the partner-side apparatus. Further, when the broadcasting communication is performed by adding the identification information peculiar to the communication terminal 3a to the data portion of the UDP, the communication terminal 3a can determine that the broadcasting transmission is addressed to the own communication terminal by the identification information of the data portion of the UDP. Thus, even in a sate that there are the plural communication terminals intended to be connected to the PC 2, the particular communication terminal 3a can change the IP address of the own communication terminal to the temporal IP address based on the notification without being confused.

When the IP address request is transmitted to the communication terminal 3a at which the temporal IP address is set, the PC 2 can establish the TCP connection in the one-to-one relation by using TCP since the IP address of the partner-side apparatus is known, so that the PC 2 can obtain the original IP address. Further, since the IP address of the partner-side apparatus is known, ICMP can be utilized by using PING (Packet Internet Groper) etc. as a network diagnostic program by designating the IP address of the partner-side apparatus. Of course, UDP may be used like the case of notifying so as to set the temporal IP address.

Further, in the communication system according to the embodiment of the invention, in the case where the temporal IP address is generated based on the identification information peculiar to the communication terminal 3a, if the original IP address of the communication terminal 3a is also generated based on the identification information peculiar to the communication terminal 3a, the original IP address may coincide with the temporal IP address with a high possibility. Thus, if the temporal IP address coincides with the original IP address, since the communication terminal 3a is not required to set the temporal IP address in place of the original IP address, the succeeding procedure can be eliminated.

Further, in the communication system according to the embodiment of the invention, in the case where the original IP address of the communication terminal 3a obtained by the PC 2 includes a network address which is different from a network address contained in the IP address of the own apparatus, the PC 2 notifies the communication terminal so as to set the IP address including the network address same as that contained in the IP address of the own apparatus. Thus, in this case, since the communication terminal 3a can set the notified network address same as that of the PC 2, there does not arise such a problem that the communication terminal can not communicate with the PC 2 due to the difference in the network address therebetween.

As shown in FIG. 3, in the communication system according to the embodiment of the invention, the PC 2 includes a status monitor portion 27 for periodically transmitting a status request to the communication terminal 3a, and the communication terminal 3a includes a status responding portion 35 which sends the status of the own communication terminal in response to the status request from the PC 2.

Like the communication system according to the embodiment of the invention, according to firewall 1 having the basic policy which is arranged to allow a communication from a partner-side apparatus responding to a communication originated from the PC 2 (own apparatus) but reject a communication originated from the partner-side apparatus, a communication originated from the communication terminal 3a outside of the firewall 1 still can not be performed even after the PC 2 obtains the IP address of the communication terminal 3a. Thus, in the communication system according to the embodiment of the invention, in the case of a communication originated from the communication terminal 3a, the status monitor portion 27 of the PC 2 periodically transmits the status request to the communication terminal 3a, and the communication terminal 3a transmits a communication in response to the status request. According to such a configuration, the communication terminal 3a can transmit the status of the own communication terminal to the PC 2.

Incidentally, the status request and the response to the status request can be performed by UDP, TCP or ICPM. As described above, since the IP address of the partner-side communication terminal is known to the PC 2, the PC 2 can establish the TCP connection in the one-to-one relation by using TCP, so that the PC2 can transmit the status request by using TCP. Further, like the aforesaid case, ICPM or UDP may be used in place of TCP in this case.

The communication system may be configured in a manner that the transmission interval of the status request from the status monitor portion 27 is dynamically changed in accordance with the status of a communication line. Accordingly, a load of the network can be reduced.

When each of the communication portion 21 of the PC 2 and the communication portion 31 of the communication terminal 3a is configured so as to perform a communication between the PC 2 and the communication terminal 3a by the layer at the level lower than that of the network layer, a communication can be performed between the PC 2 and the communication terminal 3a without being interrupted by the firewall 1.

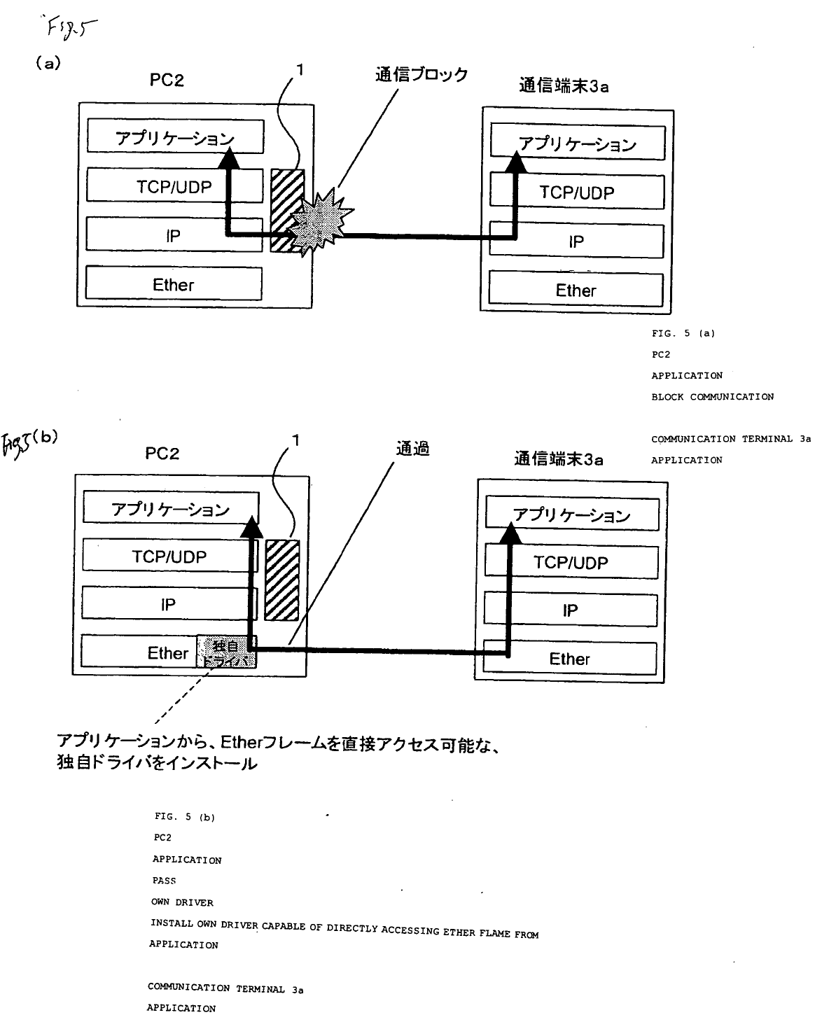

That is, as shown in FIG. 5 (a), a communication using the layer (Ether layer) at the level lower than that of the network layer (IP layer) is not limited by the firewall 1. Thus, as shown in FIG. 5 (b), a communication can be performed between the PC 2 and the communication terminal 3a by using the layer at the level lower than that of the network layer, whereby the PC 2 can obtain the change of a signal transmitted from the communication terminal 3a.

The invention is useful for the communication method, the communication system, the communication apparatus and the communication program in each of which a communication is performed via the firewall. In particular, the invention is suitable for the communication method, the communication system, the communication apparatus and the communication program each of which makes it possible, even for each of general users who is not familiar with the setting of the IP network, to automatically connect to and communicate with an apparatus within a firewall from the outside of the firewall without changing the setting of the firewall.

This application is based upon and claims the benefit of priority of Japanese Patent Application No 2005-038826 filed on May 2, 1916, the contents of which are incorporated herein by references in its entirety.

What is claimed is:

1. A communication apparatus comprising:
a communication portion, which communicates with another apparatus;
a memory portion, which stores identification information of the communication apparatus and IP address information peculiar to the communication apparatus; and
an address responding portion, which receives a first communication signal including identification information of an apparatus to be accessed from the another apparatus and a temporal IP address;
wherein the address responding portion sets the temporal IP address as an IP address used at a time of communicating at the communication portion in case such that the identification information of the apparatus to be accessed from the another apparatus coincides with the identification information of the communication apparatus, and transmits a response signal including the IP address information peculiar to the communication apparatus in case such that a second communication signal addressed to the temporal IP address is received from the another apparatus.

2. The communication apparatus according to claim 1, wherein the another apparatus is provided with a firewall.

3. The communication apparatus according to claim 1, wherein the first communication signal is a broadcasted signal.

4. The communication apparatus according to claim 3, wherein the first communication signal is a broadcasted signal in which the identification information of the apparatus to be accessed from the another apparatus is added to a data portion of UDP thereof.

5. The communication apparatus according to claim 1, wherein the temporal IP address is generated based on the identification information of the apparatus to be accessed from the another apparatus.

6. The communication apparatus according to claim 5, wherein the identification information of the apparatus to be accessed from the another apparatus is MAC address.

7. A communication apparatus comprising:
a communication portion, which communicates with another apparatus;
a memory portion, which stores identification information of an apparatus to be accessed and temporal IP address information; and
an address acquisition portion, which transmits a first communication signal including the identification information of the apparatus to be accessed and the temporal IP address information to the another apparatus,
wherein the address acquisition portion further transmits a second communication signal requesting an IP address peculiar to another apparatus toward the temporal IP address, receives a Signal including the IP address peculiar to the another apparatus in response to the second communication signal, and stores the IP address peculiar to the another apparatus in the memory portion in correspondence to the identification information of the another apparatus.

8. The communication apparatus according to claim 7, wherein the another apparatus is provided with a firewall.

9. The communication apparatus according to claim 7, wherein the first communication signal is a broadcasted signal.

10. The communication apparatus according to claim 9, wherein the first communication signal is a broadcasted signal in which the identification information of the apparatus to be accessed from the another apparatus is added to a data portion of UDP thereof.

11. The communication apparatus according to claim 7, wherein the temporal IP address is generated based on the identification information of the apparatus to be accessed from the another apparatus.

12. The communication apparatus according to claim 11, wherein the identification information of the apparatus to be accessed from the another apparatus is MAC address.

13. A method of communicating between a first apparatus and a second apparatus, comprising the steps of:
transmitting, from the first apparatus to the second apparatus, a first communication signal including identification information of an apparatus to be accessed and a temporal IP address;
setting, by the second apparatus, the temporal IP address contained in the first communication signal as an IP address used at a time of communicating at the second apparatus when the identification information of the apparatus to be accessed contained in the received first communication signal coincides with identification information of the second apparatus;
transmitting, from the first apparatus, a second communication signal requesting an IP address peculiar to the second apparatus toward the temporal IP address;
transmitting, from the second apparatus, a signal including the IP address peculiar to the second apparatus as a response signal of the second communication signal; and
receiving, at the first apparatus, the responding signal of the second communication signal and storing the IP address peculiar to the second apparatus in a memory portion in correspondence to the identification information of the second apparatus.

14. The communication method according to claim 13, wherein the another apparatus is provided with a firewall.

15. The communication method according to claim 13, wherein the first communication signal is a broadcasted signal.

16. The communication method according to claim 15, wherein the first communication signal is a broadcasted signal in which the identification information of the apparatus to be accessed from the another apparatus is added to a data portion of UDP thereof.

17. The communication method according to claim 13, wherein the temporal IP address is generated based on the identification information of the apparatus to be accessed.

18. The communication method according to claim 17, wherein the identification information of the apparatus to be accessed is MAC address.
